(19) United States
(12) Patent Application Publication
(10) Pub. No.: US 2026/0319277 A1
(43) Pub. Date: Oct. 15, 2026

(54) WAVELENGTH CALIBRATION APPARATUS AND METHOD OF RING RESONATOR

(71) Applicant: UIF (University Industry Foundation), Yonsei University, Seoul (KR)

(72) Inventors: Woo-Young CHOI, Seoul (KR); Yongjin JI, Seoul (KR); Jae-Ho LEE, Seoul (KR)

(21) Appl. No.: 19/642,334

(22) Filed: Apr. 8, 2026

(30) Foreign Application Priority Data
Apr. 10, 2025 (KR) 10-2025-0046753

(51) Int. Cl. G02F 1/01

(52) U.S. Cl. CPC G02F 1/0147; G02F 1/011; G02F 2203/15

(57) ABSTRACT

A wavelength calibration apparatus and method are disclosed for calibrating resonance wavelengths of a plurality of ring resonators coupled to a bus optical waveguide in a wavelength division multiplexing (WDM) system. A ring resonator controller generates digital-to-analog converter (DAC) codes to control heat applied to the ring resonators such that resonance wavelengths match wavelengths of optical signals. Calibration is first performed for two ring resonators to obtain calibration information including a first calibration DAC code, a second calibration DAC code, a wavelength interval DAC code, and a matching DAC code. Based on the calibration information, DAC codes corresponding to resonance wavelengths of remaining ring resonators and wavelengths of remaining optical signals are calculated, and calibration DAC codes are determined to achieve one-to-one matching. Accordingly, wavelength calibration for the plurality of ring resonators is performed rapidly, and efficient channel alignment is achieved with reduced power consumption.

### CROSS-REFERENCE TO RELATED APPLICATIONS

This application claims priority under 35 U.S.C. § 119(a) to Korean Patent Application No. 10-2025-0046753, filed on Apr. 10, 2025, with the Korean Intellectual Property Office, the disclosure of which is incorporated herein in its entirety by reference.

### BACKGROUND

### 1. Technical Field

The present disclosure relates to a wavelength calibration apparatus and method for a ring resonator, and more particularly, to a wavelength calibration apparatus and method for efficiently calibrating wavelengths in a wavelength division multiplexing (WDM) system.

### 2. Description of the Related Art

As workloads increase due to advances in artificial intelligence and machine learning, interest in wavelength division multiplexing (WDM) technology has been rapidly growing. WDM technology multiplexes a plurality of optical signals having different wavelengths, which are spaced apart by a predetermined wavelength interval (Δλ), such that the optical signals can be transmitted in a multiplexed manner through a single optical transmission medium.

In WDM systems, it is important to distinguish and detect optical signals having different wavelengths that are transmitted in a multiplexed manner. Recently, ring resonators, which can be manufactured in a compact form factor, have been widely used to detect respective optical signals. A ring resonator is a photonic device designed to resonate an optical signal of a specific wavelength. At a receiving end, the ring resonator functions as a ring resonator filter (RRF) that selectively filters an optical signal of a specific wavelength, and at a transmitting end, functions as a micro ring modulator (MRM) that modulates data onto an optical signal of a specific wavelength for transmission.

A ring resonator is capable of detecting an optical signal having a wavelength corresponding to a resonance wavelength thereof, and the resonance wavelength may be controlled based on a radius of the ring and a refractive index. Accordingly, when a target wavelength to be detected is specified, the ring resonator may be designed and manufactured by setting the radius and the refractive index such that the specified wavelength can be detected.

However, an actual resonance wavelength of the ring resonator is highly dependent on process variations during fabrication as well as temperature variations during operation. Accordingly, even if the ring resonator is designed and manufactured to have a desired resonance wavelength, wavelength calibration is required in order to match the resonance wavelength of the manufactured ring resonator to a target wavelength before actual operation.

In addition, in optical communication systems such as WDM systems, in which a plurality of optical signals having different wavelengths are transmitted, the wavelengths of the optical signals may vary depending on a system. Accordingly, it is inefficient to individually design and manufacture ring resonators for respective wavelengths used in different systems.

To address this issue, a method has been widely adopted in which a plurality of ring resonators having preset radii are manufactured, and during operation, refractive indices of the ring resonators are adjusted by changing operating temperatures of the ring resonators, such that the resonance wavelengths of the ring resonators are matched to wavelengths of optical signals required by the system. In this case, the resonance wavelengths of the plurality of ring resonators are required to be matched one-to-one with the wavelengths of the plurality of optical signals. An operation of allocating the resonance wavelengths of the plurality of ring resonators such that the resonance wavelengths are matched one-to-one with the wavelengths of the optical signals is referred to as channel alignment.

However, as the number of optical signals transmitted in a multiplexed manner in WDM systems increases due to the rapid increase in workloads, a time required for wavelength calibration of the ring resonators corresponding to the respective optical signals increases exponentially. In addition, inefficient channel alignment may result in increased power consumption.

### STATEMENT REGARDING PRIOR DISCLOSURES BY THE INVENTOR OR A JOINT INVENTOR

At least one inventor or joint inventor of the present disclosure has made related disclosures in a research paper (“A Reconfigurable 4-λ×25-Gb/s/λ Silicon Ring-Resonator-Based WDM Receiver with Fast Wavelength Calibration,” 2025 Optical Fiber Communications Conference and Exhibition (OFC), San Francisco, CA, USA, 2025, pp. 1-3.) on Apr. 3, 2025, which was included in the information disclosure statement submitted with this application.

### SUMMARY

An object of the present disclosure is to provide a wavelength calibration apparatus and method capable of performing wavelength calibration for a plurality of ring resonators at high speed.

Another object of the present disclosure is to provide a wavelength calibration apparatus and method capable of performing efficient channel alignment such that power consumption is reduced.

According to an embodiment, a wavelength calibration apparatus includes a bus optical waveguide through which a plurality of optical signals having different wavelengths are transmitted, a plurality of ring resonators sequentially coupled to the bus optical waveguide, and a ring resonator controller configured to generate a DAC code for controlling heat applied to the ring resonators such that resonance wavelengths of the ring resonators are calibrated to match wavelengths of the optical signals. The ring resonator controller is configured to adjust the DAC code and, in response to a resonance wavelength of a second ring resonator located second from an input side of the bus optical waveguide matching a wavelength of one of the plurality of optical signals, determine a second calibration DAC code for the second ring resonator, and, while a resonance wavelength of a first ring resonator located closest to the input side increases, determine a first calibration DAC code and a wavelength interval DAC code corresponding to a wavelength interval of the optical signals, and determine a matching DAC code when the resonance wavelength of the first ring resonator matches the resonance wavelength of the second ring resonator. The ring resonator controller is further configured to calculate calibration DAC codes for matching resonance wavelengths of remaining unmatched ring resonators to wavelengths of remaining optical signals based on the first calibration DAC code, the second calibration DAC code, the wavelength interval DAC code, and the matching DAC code, such that resonance wavelengths of the remaining ring resonators are matched to wavelengths of remaining optical signals.

The ring resonator controller may calculate DAC codes corresponding to resonance wavelengths of unmatched ring resonators and DAC codes corresponding to wavelengths of the optical signals, and may perform wavelength calibration by selecting matching DAC codes from among the calculated DAC codes.

The ring resonator controller may select a DAC code corresponding to a resonance wavelength of an unmatched ring resonator, identify a DAC code corresponding to a wavelength of an optical signal having a value closest to the selected DAC code, and, when the identified DAC code is greater than the selected DAC code, obtain a calibration DAC code for the ring resonator by subtracting the selected DAC code from the identified DAC code.

The ring resonator controller may select a DAC code corresponding to a resonance wavelength of an unmatched ring resonator, identify a DAC code corresponding to a wavelength of an optical signal having a value closest to the selected DAC code, and, when the identified DAC code is less than the selected DAC code, obtain a calibration DAC code for the ring resonator by subtracting the selected DAC code from an FSR DAC code corresponding to a free spectral range (FSR) of the ring resonator and adding the identified DAC code.

The ring resonator controller may count a number of optical signals that match until the resonance wavelength of the first ring resonator matches the resonance wavelength of the second ring resonator, and may calculate a resonance wavelength interval DAC code corresponding to a resonance wavelength interval of the ring resonators based on the first calibration DAC code, the second calibration DAC code, the wavelength interval DAC code, and the counted number.

The ring resonator controller may receive detection signals corresponding to optical intensities detected by the plurality of ring resonators, determine that a resonance wavelength of a ring resonator matches a wavelength of an optical signal when a peak of a detection signal is detected while adjusting the DAC code, and determine that the resonance wavelength of the first ring resonator matches the resonance wavelength of the second ring resonator in response to a peak being detected in the detection signal for the first ring resonator while a negative peak is detected in the detection signal for the second ring resonator.

The plurality of ring resonators may have different radii such that initial resonance wavelengths are spaced apart at uniform intervals.

Each of the plurality of ring resonators may include a heater configured to be heated by a heater voltage corresponding to the DAC code.

The wavelength calibration apparatus may be included in either a transmitter or a receiver of a wavelength division multiplexing system.

According to another embodiment, a wavelength calibration method includes: adjusting a digital-to-analog converter (DAC) code and, in response to a resonance wavelength of a second ring resonator located second from an input side of a bus optical waveguide matching a wavelength of one of a plurality of optical signals, determining a second calibration DAC code; determining a first calibration DAC code and a wavelength interval DAC code for a first ring resonator located closest to the input side; determining a matching DAC code in response to the resonance wavelength of the first ring resonator matching the resonance wavelength of the second ring resonator; and calculating a calibration DAC code for matching resonance wavelengths of remaining unmatched ring resonators to wavelengths of remaining optical signals based on the determined DAC codes.

According to embodiments of the present disclosure, calibration information is obtained by performing wavelength calibration on two resonance wavelengths among actual resonance wavelengths of a plurality of ring resonators designed to have uniform resonance wavelength intervals, and wavelength calibration for remaining resonance wavelengths is performed based on the obtained calibration information. Accordingly, wavelength calibration for a plurality of ring resonators can be performed at high speed, and efficient channel alignment can be achieved such that power consumption is reduced.

### BRIEF DESCRIPTION OF THE DRAWINGS

FIG. 1 illustrates a schematic structure of a wavelength calibration apparatus for a WDM optical receiver according to an embodiment of the present disclosure.

FIG. 2 is a diagram for explaining resonance wavelength characteristics of the ring resonators of FIG. 1.

FIG. 3 is a diagram for explaining a wavelength calibration technique of the wavelength of calibration apparatus FIG. 1.

FIG. 4 illustrates a schematic structure of a wavelength calibration apparatus for a WDM optical transmitter according to an embodiment of the present disclosure.

FIG. 5 is a diagram for explaining a wavelength calibration technique of the wavelength calibration apparatus of FIG. 4.

FIG. 6 is a flowchart illustrating a wavelength calibration method according to an embodiment of the present disclosure.

### DETAILED DESCRIPTION

Hereinafter, specific embodiments of the present disclosure will be described with reference to the drawings. The following detailed description is provided to help with comprehensive understanding of a method, a device, and/or a system described in this specification. However, this is only an example, and the present disclosure is not limited thereto.

In describing embodiments of the present disclosure, when it is determined that detailed description of well-known technologies related to the present disclosure may unnecessarily obscure the gist of embodiments, the detailed description will be omitted. Terms to be described below are terms defined in consideration of functions in the present disclosure, and may vary depending on the intention, practice, or the like of a user or operator. Therefore, the terms should be defined on the basis of the overall content of this specification. Terms used in the detailed description are only used to describe embodiments and should not be construed as limiting. Unless otherwise clearly specified, a singular expression includes the plural meaning. In this description, an expression such as “include” or “have” is intended to indicate certain features, numerals, steps, operations, elements, or some or combinations thereof, and should not be construed as excluding the presence or possibility of one or more other features, numerals, steps, operations, elements, or some or combinations thereof. Also, the terms “unit,” “device,” “module,” “block,” and the like described in this specification refer to units for processing at least one function or operation, which may be implemented by hardware, software, or a combination of hardware and software.

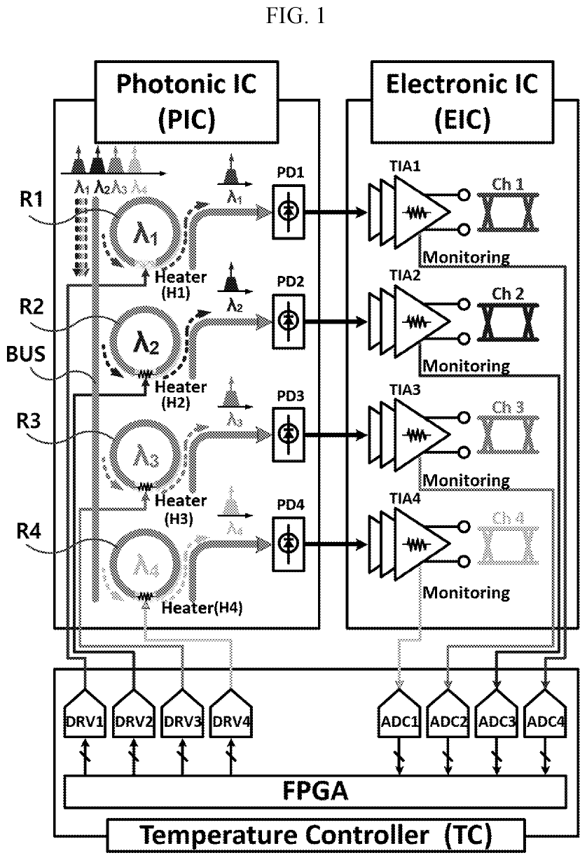

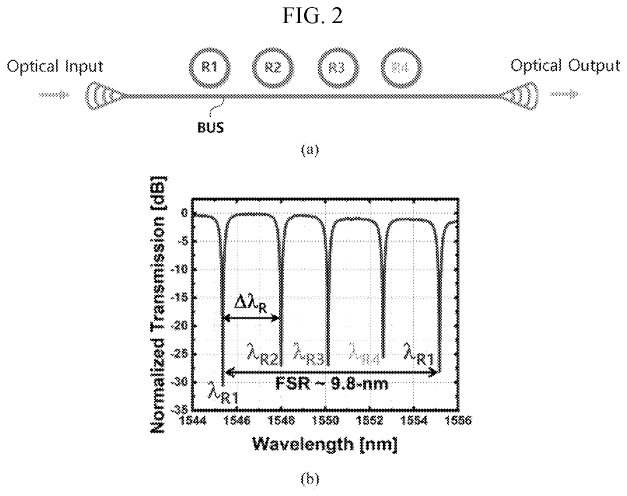

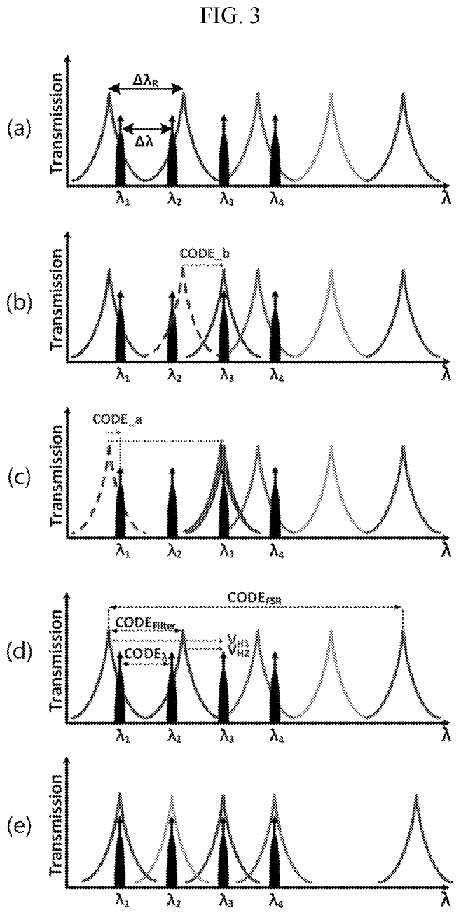

FIG. 1 illustrates a schematic structure of a wavelength calibration apparatus for a WDM optical receiver according to an embodiment, FIG. 2 is a diagram for explaining resonance wavelength characteristics of ring resonators of FIG. 1, and FIG. 3 is a diagram for explaining a wavelength calibration technique of the wavelength calibration apparatus of FIG. 1.

Referring to FIG. 1, a wavelength calibration apparatus for a WDM optical receiver according to an embodiment may include a photonic circuit PIC, an electronic circuit EIC, and a temperature controller TC. The photonic circuit PIC may be implemented as a photonic integrated circuit, and the electronic circuit EIC may be implemented as an electronic integrated circuit. Although the temperature controller is illustrated separately in FIG. 1 for convenience of explanation, the temperature controller TC may also be included in the electronic circuit EIC and implemented as a single integrated circuit, and the electronic circuit EIC and the temperature controller TC may be collectively referred to as a ring resonator controller.

The photonic circuit PIC may include a bus optical waveguide BUS, a plurality of ring resonators R1 to Rn, and a plurality of photodetectors PD1 to PDn. The plurality of ring resonators R1 to Rn and the plurality of photodetectors PD1 to PDn may be provided in a number corresponding to the number n of optical signals transmitted in a multiplexed manner in a WDM system. For convenience of description, a four-channel WDM system in which four optical signals having different wavelengths λ₁ to λ₄ are transmitted in a multiplexed manner is assumed, and accordingly, it is assumed that the photonic circuit PIC includes four ring resonators R1 to R4 and four photodetectors PD1 to PD4.

The bus optical waveguide BUS receives a multi-wavelength optical signal including a plurality of optical signals having different wavelengths λ1 to λ4, which are multiplexed and transmitted from a WDM optical transmitter through an optical transmission medium such as an optical cable, and is coupled to the plurality of ring resonators R1 to R4 such that an optical signal having a wavelength matching a resonance wavelength λ_{R1} to λ_{R4} of each of the ring resonators R1 to R4 is transmitted to the corresponding ring resonator.

The plurality of ring resonators R1 to R4 are sequentially coupled to the bus optical waveguide BUS and each have a designated resonance wavelength λ_{R1} to λ_{R4}. The plurality of ring resonators R1 to R4 extract an optical signal having a wavelength matching the resonance wavelength λ_{R1} to λ_{R4} from among optical signals transmitted through the bus optical waveguide BUS. In this case, the plurality of ring resonators R1 to R4 are configured to detect optical signals of four channels having different wavelengths λ1 to λ4, and are sequentially referred to as first to fourth ring resonators R1 to R4 from a position closest to an input end of the bus optical waveguide BUS through which the multi-wavelength optical signal is input. Optical signals detected by the first to fourth ring resonators R1 to R4 are referred to as first to fourth channel optical signals, respectively.

Meanwhile, the resonance wavelengths λ_{R1} to λ_{R4} of the ring resonators R1 to R4 do not appear only as a single wavelength but appear repeatedly at a predetermined wavelength interval, and a wavelength interval at which the resonance wavelengths are repeatedly generated is referred to as a free spectral range (FSR).

In FIG. 2, part (a) illustrates four ring resonators R1 to R4 coupled to the bus optical waveguide BUS in the photonic circuit PIC, and part (b) illustrates an intensity of an optical signal according to wavelength transmitted through the bus optical waveguide BUS.

As described above, among optical signals transmitted through the bus optical waveguide BUS, an optical signal having a wavelength matching the resonance wavelength λ_{R1} to λ_{R4} of each of the ring resonators R1 to R4 is coupled into the ring resonators R1 to R4. Accordingly, as illustrated in (b) of FIG. 2, an intensity of a received optical signal corresponding to the resonance wavelength λ_{R1} to λ_{R4} of each of the ring resonators R1 to R4 is reduced in the bus optical waveguide BUS. That is, each of the plurality of ring resonators R1 to R4 extracts an optical signal having the same wavelength as the resonance wavelength λ_{R1} to λ_{R4} from among optical signals transmitted through the bus optical waveguide BUS.

In (b) of FIG. 2, only the resonance wavelength λ_{R1} of the first ring resonator R1 is illustrated as repeatedly appearing to represent the free spectral range, but resonance wavelengths λ_{R2} to λ_{R4} of the remaining ring resonators R2 to R4 also appear repeatedly at the same free spectral range interval. Since resonance wavelengths λ_{R1} to λ_{R4} of each of the ring resonators R1 to R4 appear repeatedly at intervals of the free spectral range, wavelength calibration for each of the ring resonators R1 to R4 is performed within the free spectral range.

Meanwhile, in an embodiment, the plurality of ring resonators R1 to R4 are designed and manufactured such that a resonance wavelength interval ΔλR between resonance wavelengths λ_{R1} to λ_{R4} is uniform. That is, the plurality of ring resonators R1 to R4 are designed and manufactured such that resonance wavelength intervals Δλ_{R} between adjacent ring resonators are equally spaced.

As described above, resonance wavelengths λ_{R1} to λ_{R4} of the ring resonators R1 to R4 depend on a radius and a refractive index of the ring. Accordingly, by adjusting radii of the plurality of ring resonators R1 to R4 during design, the resonance wavelength intervals Δλ_{R} between the ring resonators may be made uniform. Since the resonance wavelengths λ_{R1} to λ_{R4} appear repeatedly within the free spectral range, as illustrated in (b) of FIG. 2, the plurality of ring resonators R1 to R4 are designed and manufactured to have a constant resonance wavelength interval Δλ_{R} within the free spectral range.

Referring to (b) of FIG. 2, resonance wavelengths λ_{R1} to λ_{R4} of the plurality of ring resonators R1 to R4 are equally spaced at the resonance wavelength interval Δλ_{R} within the free spectral range of the first ring resonator R1. The resonance wavelengths λ_{R1} to λ_{R4} are repeated at the free spectral range interval while maintaining the uniform resonance wavelength interval Δλ_{R}.

Meanwhile, each of the plurality of ring resonators R1 to R4 includes a heater H1 to H4 for adjusting the resonance wavelengths λ_{R1} to λ_{R4}. Each of the heaters H1 to H4 may be implemented as a resistive element and is heated according to an applied heater voltage V_{HEATER} to change an operating temperature of the corresponding ring resonator R1 to R4, thereby adjusting the resonance wavelength λ_{R1} to λ_{R4}.

As described above, the ring resonators R1 to R4 have characteristics in which refractive indices are changed according to operating temperatures, and resonance wavelengths λ R1 to λ_{R4} are changed accordingly. In this case, the resonance wavelengths λ_{R1} to λ_{R4} vary in proportion to the operating temperatures. That is, when the temperatures increase, the resonance wavelengths λ_{R1} to λ_{R4} of the ring resonators R1 to R4 increase, and when the temperatures decrease, the resonance wavelengths λ_{R1} to λ_{R4} of the ring resonators R1 to R4 decrease accordingly. However, the heaters H1 to H4 are capable of increasing the operating temperatures of the ring resonators R1 to R4 but are not capable of decreasing the operating temperatures. The operating temperatures of the ring resonators R1 to R4 may decrease due to natural cooling while the heaters H1 to H4 are not heated, but such cooling is limited to a very narrow temperature range and is significantly affected by surrounding environments.

Accordingly, wavelength calibration of the ring resonators R1 to R4 is generally performed by increasing temperatures using the heaters H1 to H4 to increase the resonance wavelengths, thereby matching the resonance wavelengths to required wavelengths. Although the heaters H1 to H4 have a limitation in that they can only increase temperatures, as described above, the resonance wavelengths λ_{R1} to λ_{R4} of the ring resonators R1 to R4 appear repeatedly in units of a free spectral range (FSR), and thus resonance wavelengths λ_{R1} to λ_{R4} lower than wavelengths λ₁ to λ₄ of optical signals to be detected may increase with temperature and match the wavelengths λ₁ to λ₄ of the optical signals. Accordingly, even when wavelength calibration for each of the ring resonators R1 to R4 is performed only within the FSR, wavelength calibration may be performed such that the resonance wavelengths are matched to required wavelengths of the optical signals.

The heaters H1 to H4 may be implemented, for example, as metal heaters that are easily implemented in a photonic circuit PIC, but may also be implemented using various other resistive elements.

The plurality of photodetectors PD1 to PD4 detect intensities of optical signals extracted from the bus optical waveguide BUS by the respective ring resonators R1 to R4. Since the plurality of ring resonators R1 to R4 extract optical signals having wavelengths corresponding to the resonance wavelengths λ_{R1} to λ_{R4}, intensities of optical signals transmitted to the ring resonators R1 to R4 increase by an amount corresponding to a decrease in optical signal intensity in the bus optical waveguide BUS as illustrated in (b) of FIG. 2. The photodetectors PD1 to PD4 detect intensities of optical signals corresponding to the resonance wavelengths λ_{R1} to λ_{R4} extracted from optical signals transmitted through the bus optical waveguide BUS.

The photodetectors PD1 to PD4 may be implemented as photodiodes that generate detection currents according to detected optical intensities.

The electronic circuit EIC includes a plurality of transimpedance amplifiers TIA1 to TIA4 that convert and amplify detection currents generated by the photonic circuit PIC into detection signals, which are voltage signals.

The temperature controller may include a plurality of analog-to-digital converters ADC1 to ADC4, a plurality of digital-to-analog converters DAC1 to DAC4, and a digital processing unit DPU. The plurality of analog-to-digital converters ADC1 to ADC4 convert detection signals received from the transimpedance amplifiers TIA1 to TIA4 into digital detection data. The plurality of digital-to-analog converters DAC1 to DAC4 generate heater voltages V_{HEATER} corresponding to DAC codes provided from the digital processing unit DPU and apply the heater voltages to the heaters H1 to H4 of the ring resonators R1 to R4, thereby causing the heaters to be heated. When the heaters are heated by the heater voltages V_{HEATER}, operating temperatures of the ring resonators increase, and accordingly, the resonance wavelengths λ_{R1} to λ_{R4} increase.

In this case, the digital-to-analog converters DAC1 to DAC4 may be configured such that the resonance wavelengths of the ring resonators increase in proportion to the DAC codes. For example, when a DAC code is a 4-bit value of 0100, the resonance wavelength may increase by 1 nm, and when the DAC code is 1000, the resonance wavelength may increase by 2 nm.

The digital processing unit DPU may generate DAC codes for controlling the plurality of digital-to-analog converters DAC1 to DAC4 based on detection data received from the plurality of analog-to-digital converters ADC1 to ADC4. For example, the digital processing unit DPU may determine whether resonance wavelengths λ_{R1} to λ_{R4} of the ring resonators match wavelengths λ₁ to λ₄ of optical signals by gradually increasing DAC codes for the respective ring resonators and detecting peaks in detection data received from the analog-to-digital converters ADC1 to ADC4. When a peak is detected in the detection data and it is determined that a resonance wavelength matches a wavelength of an optical signal, a DAC code corresponding to the detected peak may be determined as a calibration DAC code.

In this case, the digital processing unit DPU sequentially performs wavelength calibration such that resonance wavelengths of the ring resonators are matched one-to-one with wavelengths of the optical signals starting from the first ring resonator R1. That is, when a resonance wavelength λ_{R1} of the first ring resonator R1 is calibrated to match a wavelength of an optical signal having a closest higher wavelength, wavelength calibration is then performed for a second ring resonator R2 such that a resonance wavelength λ_{R2} is matched to a corresponding optical signal, and this process is repeated sequentially. In some cases, wavelength calibration may be performed only when resonance wavelengths of all of the ring resonators are matched to predetermined wavelengths of optical signals.

However, in such a method, as a number of ring resonators increases, that is, as a number of channels increases, a time required for wavelength calibration increases exponentially. In addition, since wavelength calibration is performed individually for the respective ring resonators, power consumption may increase because power required for wavelength calibration of all ring resonators is not collectively considered. As described above, wavelength calibration is performed by increasing heater voltages V_{HEATER} to heat the heaters, thereby increasing operating temperatures of the ring resonators. As a difference between resonance wavelengths λ_{R1} to λ_{R4} of the ring resonators and wavelengths λ₁ to λ₄ of optical signals increases, more power is required to heat the heaters. In particular, since the heaters are capable of increasing temperatures but not decreasing temperatures, it is necessary to perform wavelength calibration efficiently in consideration of characteristics of resonance wavelength variation in order to reduce power consumption.

Accordingly, the digital processing unit DPU according to an embodiment employs a wavelength calibration technique that rapidly calibrates wavelengths for all ring resonators while reducing power consumption.

Hereinafter, a technique in which the digital processing unit DPU performs wavelength calibration will be described with reference to FIG. 3.

In (a) of FIG. 3, wavelengths λ₁ to λ₄ of optical signals and initial resonance wavelengths λ_{R1} to λ_{R4} of ring resonators R1 to R4 are illustrated. As described above, a plurality of optical signals have wavelengths λ₁ to λ₄ spaced apart by a uniform wavelength interval Δλ, and a plurality of ring resonators R1 to R4 are also manufactured such that initial resonance wavelengths λ_{R1} to λ_{R4} are spaced apart by a uniform resonance wavelength interval Δλ_{R}. In this case, the digital processing unit DPU may apply initial DAC codes, for example, 0000, to digital-to-analog converters DAC1 to DAC4 such that heater voltages V_{HEATER} having a reference voltage level, for example, 0 V, are applied to heaters H1 to H4.

Even if the ring resonators R1 to R4 are designed and manufactured to have designated resonance wavelengths, initial resonance wavelengths λ_{R1} to λ_{R4} of the ring resonators R1 to R4 in actual operation vary due to process variations and operating temperatures, and the varied initial resonance wavelengths λ_{R1} to λ_{R4} cannot be known in advance. However, since the ring resonators R1 to R4 are manufactured under the same process and operate within the same photonic circuit PIC, the initial resonance wavelengths λ_{R1} to λ_{R4} maintain uniform spacing corresponding to the resonance wavelength interval Δλ_{R}.

Accordingly, in an embodiment, based on characteristics that a plurality of optical signals have wavelengths λ₁ to λ₄ spaced apart by a uniform wavelength interval Δλ and a plurality of ring resonators R1 to R4 are manufactured such that initial resonance wavelengths λ_{R1} to λ_{R4} are spaced apart by a uniform resonance wavelength interval Δλ_{R}, the digital processing unit DPU converts relationships between the initial resonance wavelengths λ_{R1} to λ_{R4} of the plurality of ring resonators R1 to R4 and the wavelengths λ₁ to λ₄ of the optical signals into DAC codes, and performs calculation based on relationships expressed in terms of the DAC codes such that the initial resonance wavelengths λ_{R1} to λ_{R4} of the ring resonators R1 to R4 are matched to the wavelengths λ₁ to λ₄ of the optical signals, thereby enabling wavelength calibration to be performed at high speed.

The digital processing unit DPU first selects one ring resonator other than the first ring resonator R1, among the plurality of ring resonators R1 to R4 sequentially coupled to a bus optical waveguide BUS, for example, a second ring resonator R2, and performs wavelength calibration for the selected ring resonator R2 as illustrated in (b) of FIG. 2. The digital processing unit DPU gradually increases a second DAC code applied to a second digital-to-analog converter DAC2 corresponding to the selected ring resonator R2 among the digital-to-analog converters DAC1 to DAC4, detects a peak in second detection data obtained from a second analog-to-digital converter ADC2, and determines whether a resonance wavelength λ_{R2} of the second ring resonator R2 matches a nearest higher wavelength among the optical signals, for example, a third wavelength λ₃, among the plurality of optical signals. When the resonance wavelength λ_{R2} of the second ring resonator R2 matches the wavelength λ₃ of one optical signal, a value of the second DAC code at that time is stored as a second calibration DAC code value CODE_b.

Thereafter, the digital processing unit DPU performs wavelength calibration for the first ring resonator R1 located at an input side of the selected second ring resonator R2, and increases a resonance wavelength λ_{R1} of the first ring resonator R1 until the resonance wavelength λ_{R1} becomes equal to the calibrated resonance wavelength λ_{R2} (=λ₃) of the second ring resonator R2.

Specifically, the digital processing unit DPU gradually increases a first DAC code applied to a first digital-to-analog converter DAC1, detects a peak in first detection data obtained from a first analog-to-digital converter ADC1, and determines whether the resonance wavelength λ_{R1} of the first ring resonator R1 matches a nearest higher wavelength among the optical signals, for example, a first wavelength λ1, and stores a value of the first DAC code at that time as a first calibration DAC code value CODE_a.

Thereafter, the digital processing unit DPU continues to increase the first DAC code even after obtaining the first calibration DAC code value CODE_a. The digital processing unit DPU continues to increase the first DAC code until a negative peak appears in second detection data obtained from the second analog-to-digital converter ADC2 corresponding to the second ring resonator R2.

When the first DAC code is continuously increased such that the resonance wavelength λ_{R1} of the first ring resonator R1 increases to the calibrated resonance wavelength λ_{R2} of the second ring resonator R2, the resonance wavelength λ_{R1} of the first ring resonator R1 and the calibrated resonance wavelength λ_{R2} of the second ring resonator R2 become equal to the same wavelength λ₃. When the resonance wavelength λ_{R1} of the first ring resonator R1 and the calibrated resonance wavelength λ_{R2} of the second ring resonator R2 become equal, an optical signal of the wavelength λ₃ is first extracted from the bus optical waveguide BUS by the first ring resonator R1 located at the input side, and accordingly, the optical signal of the wavelength λ₃ detected by the second ring resonator R2 is no longer extracted, thereby causing a negative peak in the second detection data.

Accordingly, the digital processing unit DPU increases the first DAC code and monitors changes in the second detection data, and when a negative peak appears in the second detection data, determines that the resonance wavelength λ_{R1} of the first ring resonator R1 matches the calibrated resonance wavelength λ_{R2} (=λ3) of the second ring resonator R2.

The digital processing unit DPU obtains and stores, as a matching DAC code value, a value of a first DAC code that appears when the resonance wavelength λ_{R1} of the first ring resonator R1 matches the calibrated resonance wavelength λ_{R2} (=λ₃) of the second ring resonator R2. At the same time, until the matching occurs, the digital processing unit DPU counts a number m of peaks appearing in first detection data that changes as the first DAC code is varied, and calculates a difference between values of the first DAC code changed until two consecutive peaks appear, thereby obtaining, as a wavelength interval DAC code value CODE_{λ}, a DAC code value required while the resonance wavelength λ_{R1} moves across a wavelength interval Δλ between adjacent wavelengths, for example λ₁ and λ₂, among the wavelengths λ₁ to λ₄ of the plurality of optical signals. If only one peak appears until the resonance wavelength λ_{R1} of the first ring resonator R1 matches the calibrated resonance wavelength λ_{R2} (=λ₃) of the second ring resonator R2, the digital processing unit DPU counts the number m of peaks as one, and increases the first DAC code until a next peak is detected in the first detection data, thereby obtaining the wavelength interval DAC code value CODE_{λ}.

Accordingly, a matching DAC code value, which is represented as a change in a value of the first DAC code until the resonance wavelength λ_{R1} of the first ring resonator R1 overlaps and matches the calibrated resonance wavelength λ_{R2} of the second ring resonator R2 at the third wavelength λ₃, is represented identically as (CODE_a+(m−1)CODE_{λ}) based on a value CODE_a of the first DAC code according to wavelength calibration of the first ring resonator R1, a wavelength interval DAC code value CODE_{λ}, and a detected number m of peaks.

As an example, as shown in (c) of FIG. 3, until the resonance wavelength λ_{R1} of the first ring resonator R1 matches the calibrated resonance wavelength λ_{R2} of the second ring resonator R2 at the third wavelength λ₃, three peaks (m=3) are detected at each of the first to third wavelengths λ₁ to λ₃. Accordingly, the matching DAC code value representing a change in the value of the first DAC code for the first ring resonator R1 is represented identically as (CODE_a+2*CODE_{λ}).

The digital processing unit DPU may calculate, based on the value CODE_a of the first DAC code according to wavelength calibration of the first ring resonator R1, the wavelength interval DAC code value CODE_{λ}, and a value CODE_b of the second DAC code according to wavelength calibration of the second ring resonator R2, a resonance wavelength interval DAC code value CODEFilter corresponding to a wavelength interval Δλ_{R} between initial resonance wavelengths of the plurality of ring resonators R1 to R4, as shown in Equation 1.

CODE_{Filter}CODE_a+(m−1)CODE_{λ}−CODE_b [Equation 1]

Further, in an n-channel WDM system, an FSR DAC code value CODE_{FSR} corresponding to a free spectral range (FSR) may be expressed by Equation 2.

CODE_{FSR}=N*CODE_{Filter} [Equation 2]

As a result, each of resonance wavelengths λ_{R1} to λ_{R4} of the plurality of ring resonators R1 to R4 and wavelengths λ₁ to λ₄ of input optical signals may all be expressed as relative DAC code values with respect to the resonance wavelength λ_{R1} of the first ring resonator R1.

Specifically, among n ring resonators R1 to Rn, a DAC code value CODE_Rk for a resonance wavelength λ_{Rk} of a k-th ring resonator Rₖ may be expressed as shown in Equation 3.

CODE_Rₖ=(k−1)CODE_{Filter} [Equation 3]

Further, among n optical signals, a DAC code value CODE_Oⱼ for a wavelength λⱼ of a j-th optical signal Oj may be expressed as shown in Equation 4.

CODE_Oⱼ=CODE_a+(m−1)CODE_{λ} [Equation 4]

Here, m represents a number of optical signals having wavelengths included between the first resonance wavelength λ_{R1} and the wavelength λⱼ of the j-th optical signal Oⱼ.

When DAC code values CODE_R1 to CODE_Rn for resonance wavelengths λ_{R1} to λ_{Rn} of the plurality of ring resonators R1 to Rn and DAC code values CODE_O₁ to CODE_Oₙ for wavelengths λ₁ to λₙ of the plurality of optical signals are obtained, the digital processing unit DPU may obtain, through calculation, all DAC codes for performing wavelength calibration such that the resonance wavelengths λ_{R1} to λ_{Rn} of the plurality of ring resonators R1 to Rn are matched one-to-one with the wavelengths λ₁ to λₙ of the plurality of optical signals.

The digital processing unit DPU may obtain, for each of remaining ring resonators R3 to Rn excluding the first and second ring resonators R1 and R2 for which wavelength calibration has been performed, DAC codes for performing wavelength calibration from the DAC code values CODE_O₁ to CODE_Oₙ for the optical signals obtained by Equations 3 and 4 and DAC code values CODE_R₃ to CODE_Rₙ for the resonance wavelengths λ_{R3} to λ_{Rn} of the ring resonators R3 to Rn, in the following manner.

The digital processing unit DPU sequentially selects ring resonators R3 to Rn for which wavelength calibration is to be performed, and identifies, from among DAC code values CODE_R₃ to CODE_Rₙ corresponding to wavelengths λ₂, λ₄ to λₙ of optical signals that have not previously been assigned to other ring resonators, a DAC code value CODE_Rk corresponding to a resonance wavelength λ_{Rk} of a selected ring resonator Rk and a DAC code value CODE_O₃, CODE_O₄ to CODE_Oₙ corresponding to a wavelength λ₂, λ₄ to λₙ of an optical signal closest thereto.

When the DAC code value CODE_Oⱼ corresponding to the closest wavelength λⱼ is identified, it is determined whether the identified DAC code value CODE_Oⱼ is greater than the DAC code value CODE_Rk corresponding to the resonance wavelength λ_{Rk} of the selected ring resonator Rk.

If the identified DAC code value CODE_Oⱼ is greater than the DAC code value CODE_Rk corresponding to the resonance wavelength λRk of the selected ring resonator Rk, as shown in Equation 5, a j-th calibration DAC code value CODE_j for calibrating the resonance wavelength λ_{Rk} of the k-th ring resonator Rk to the wavelength λj of the j-th optical signal may be obtained by subtracting the DAC code value CODE_Rk corresponding to the resonance wavelength λ_{Rk} of the selected ring resonator Rk from the DAC code value CODE_Oⱼ corresponding to the wavelength λj of the identified optical signal.

CODE_j=CODE_Oⱼ−CODE_Rₖ [Equation 5]

However, if the identified DAC code value CODE_Oⱼ is less than the DAC code value CODE_Rk corresponding to the resonance wavelength λ_{Rk} of the selected ring resonator Rk, wavelength calibration should be performed using another resonance wavelength differing by the FSR. Accordingly, as shown in Equation 6, a j-th calibration DAC code value CODE_j for calibrating the resonance wavelength λ_{Rk} of the k-th ring resonator Rk to the wavelength λⱼ of the j-th optical signal may be obtained by subtracting the DAC code value CODE_Rk corresponding to the resonance wavelength λ_{Rk} of the selected ring resonator Rk from the FSR DAC code value CODE_{FSR} and adding the DAC code value CODE_Oⱼ corresponding to the wavelength λj of the identified optical signal.

CODE_j=(CODE_{FSR}−CODE_Rₖ)+CODE_Oⱼ [Equation 6]

Therefore, the wavelength calibration apparatus according to an embodiment actually performs wavelength calibration only for two ring resonators R1 and R2 located at a front stage, thereby obtaining a resonance wavelength interval DAC code value CODE_{Filter} according to a wavelength difference (λ_{R2}−λ_{R1}) between initial resonance wavelengths λ_{R1} and λ_{R2} of the two ring resonators R1 and R2, a wavelength interval DAC code value CODEλ according to a wavelength difference (λ₂−λ₁) of optical signals, and an FSR DAC code value CODE_{FSR} for the FSR. Further, DAC code values CODE_R3 to CODE_Rn corresponding to resonance wavelengths λ_{R3} to λRₙ of the remaining plurality of ring resonators R3 to Rn and DAC code values CODE_O₃, CODE_O₄ to CODE_Oₙ corresponding to wavelengths λ₂, λ₄ to λₙ of other optical signals are calculated and obtained as relative values based on the initial resonance wavelength λ_{R1} of the first ring resonator R1.

Thereafter, among the obtained DAC code values CODE_R3 to CODE_Rn corresponding to resonance wavelengths λ_{R3} to λ_{Rn} of the remaining plurality of ring resonators R3 to Rn and DAC code values CODE_O3, CODE_O4 to CODE_On corresponding to wavelengths λ₂, λ₄ to λₙ of other optical signals, DAC code values CODE_Rk and CODE_Oⱼ close to each other are searched for and assigned, and according to the relative magnitude between the assigned DAC code values CODE_Rk and CODE_Oⱼ, a calibration DAC code value CODE_j for calibrating each ring resonator R3 to Rn may be directly obtained through calculation according to Equation 5 or Equation 6. That is, the calibration DAC code value CODE_j may be immediately obtained through a simple calculation without performing an actual wavelength calibration operation. In addition, since the resonance wavelength λ_{R1} to λ_{Rn} of each ring resonator R1 to Rn is assigned to a wavelength λ₁ to λₙ of the closest optical signal, power consumption for wavelength calibration due to channel alignment may be reduced.

The wavelength calibration apparatus of the digital processing unit DPU may first operate in a scan mode to perform the above-described wavelength calibration operation. The digital processing unit DPU may further perform fine calibration such that the resonance wavelengths λ_{R1} to λ_{Rn} accurately match the wavelengths λ₁ to λₙ of the optical signals by applying dithering and a track mode.

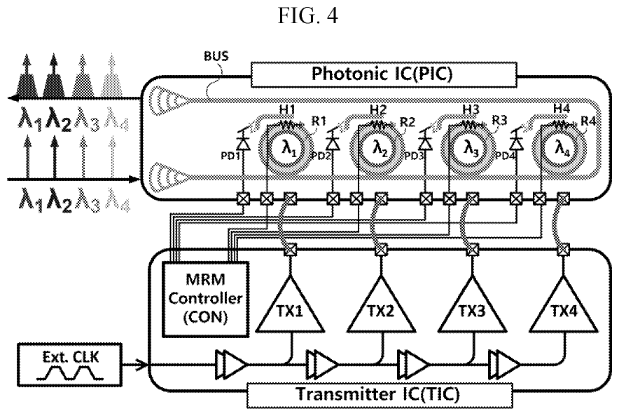

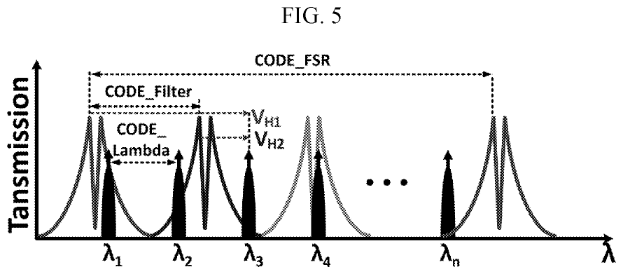

FIG. 4 illustrates a schematic structure of a wavelength calibration apparatus for a WDM optical transmitter according to an embodiment, and FIG. 5 illustrates a wavelength calibration technique of the wavelength calibration apparatus of FIG. 4.

Referring to FIG. 4, the wavelength calibration apparatus for an optical transmitter may include a photonic circuit PIC and a transmission circuit TIC. Here, the photonic circuit PIC may be implemented as a photonic integrated circuit, and the transmission circuit TIC may be implemented as an electronic integrated circuit, similar to the electronic circuit EIC of FIG. 1.

The photonic circuit PIC may include a bus optical waveguide BUS, a plurality of ring resonators R1 to Rn, and a plurality of photodetectors PD1 to PDn, and the number of the ring resonators R1 to Rn and the photodetectors PD1 to PDn may be the same as the number n of optical signals multiplexed and transmitted in a WDM system.

The bus optical waveguide BUS receives a plurality of optical signals having different wavelengths λ₁ to λ₄ generated from a plurality of light sources (not shown). The bus optical waveguide BUS is coupled with the plurality of ring resonators R1 to R4 such that, among the multi-wavelength optical signals, optical signals having wavelengths matching the resonance wavelengths λ_{R1} to λ_{R4} of the ring resonators R1 to R4 are transmitted to the ring resonators.

Here also, the plurality of ring resonators R1 to R4 are sequentially coupled to the bus optical waveguide BUS and extract optical signals having wavelengths matching the resonance wavelengths λ_{R1} to λ_{R4} from among the optical signals transmitted through the bus optical waveguide BUS. At this time, the plurality of ring resonators R1 to R4 modulate transmission signals TX1 to TX4 into optical signals by selectively extracting or not extracting optical signals of specific wavelengths through adjustment of refractive indices according to transmission signals TX1 to TX4 applied from the transmission circuit TIC.

Each of the plurality of ring resonators R1 to R4 is coupled with a heater H1 to H4 for adjusting the resonance wavelengths λ_{R1} to λ_{R4} of the ring resonators R1 to R4, and the resonance wavelengths λ_{R1} to λ_{R4} of the ring resonators R1 to R4 may be adjusted by changing operating temperatures of the ring resonators R1 to R4 according to heater voltages V_{HEATER} applied from an MRM controller CON. The plurality of photodetectors PD1 to PD4 detect intensities of optical signals extracted from the bus optical waveguide BUS by the respective ring resonators R1 to R4.

The transmission circuit TIC generates a plurality of transmission signals TX1 to TX4 and provides the transmission signals TX1 to TX4 to the plurality of ring resonators R1 to R4 such that the plurality of ring resonators R1 to R4 perform optical modulation. Meanwhile, the transmission circuit TIC includes an MRM controller CON. The MRM controller CON corresponds to the ring resonator controller corresponding to the electronic circuit EIC and the temperature controller TC of FIG. 1, and may include a plurality of transimpedance amplifiers TIA1 to TIA4, a plurality of analog-to-digital converters ADC1 to ADC4, a plurality of digital-to-analog converters DAC1 to DAC4, and a digital processing unit DPU.

The plurality of transimpedance amplifiers TIA1 to TIA4 convert and amplify detection currents generated in the photonic circuit PIC into detection signals, which are voltage signals, and the plurality of analog-to-digital converters ADC1 to ADC4 convert detection signals obtained from the plurality of transimpedance amplifiers TIA1 to TIA4 into digital detection data. The plurality of digital-to-analog converters DAC1 to DAC4 generate heater voltages V_{HEATER} corresponding to DAC codes provided from the digital processing unit DPU and apply the heater voltages V_{HEATER} to the heaters H1 to H4 of the ring resonators R1 to R4 such that the heaters H1 to H4 are heated.

The digital processing unit DPU, as in FIG. 1, performs actual wavelength calibration only for two ring resonators R1 and R2 among the plurality of ring resonators R1 to R4, and performs wavelength calibration for the remaining ring resonators R3 and R4 through calculation using a first calibration DAC code value CODE_a, a wavelength interval DAC code value CODE_{λ}, an FSR DAC code value CODE_{FSR}, and a resonance wavelength interval DAC code value CODE_{Filter} obtained while performing wavelength calibration for the two ring resonators R1 and R2.

However, in the case of the optical receiver illustrated in FIG. 1, as shown in FIG. 3, a detection signal obtained from each of the ring resonators R1 to R4 has a single peak, whereas in the optical transmitter, as shown in FIG. 5, two peaks appear in the detection signal. Accordingly, the digital processing unit DPU differs only in that wavelength calibration is performed based on only one designated peak among the two peaks appearing in each detection signal, either a left peak or a right peak, and otherwise performs wavelength calibration in the same manner as the digital processing unit DPU of FIG. 1.

The digital processing unit DPU obtains a second calibration DAC code value CODE_b by gradually increasing a value of a second DAC code applied to a second DAC DAC2 corresponding to the second ring resonator R2 among the plurality of DACs DAC1 to DAC4 and performing wavelength calibration by detecting a peak of second detection data obtained from a second ADC ADC2.

Further, the digital processing unit DPU obtains a first calibration DAC code value CODE_a by gradually increasing a value of a first DAC code applied to a first DAC DAC1 corresponding to the first ring resonator R1 and performing wavelength calibration by detecting a peak of first detection data obtained from a first ADC ADC1. Thereafter, while continuing to increase the value of the first DAC code, the digital processing unit DPU repeatedly detects peaks of the first detection data and obtains a wavelength interval DAC code value CODE_{λ}by identifying changes in the value of the first DAC code between the detected peaks. Further, when a negative peak of the second detection data is detected while the value of the first DAC code is increased, the digital processing unit DPU counts a number m of peaks of the first detection data detected up to that time and obtains a resonance wavelength interval DAC code value CODE_{Filter} and an FSR DAC code value CODE_{FSR} according to Equations 1 and 2.

When the first calibration DAC code value CODE_a, the resonance wavelength interval DAC code value CODE_{Filter}, and the FSR DAC code value CODE_{FSR} are obtained, DAC code values CODE_Rk for resonance wavelengths λRk of respective ring resonators Rk and DAC code values CODE_Oⱼ for wavelengths λⱼ of respective optical signals Oⱼ are calculated according to Equations 3 and 4.

Further, using the calculated DAC code values CODE_Rk for the resonance wavelengths λ_{Rk} of the respective ring resonators Rk and the DAC code values CODE_Oⱼ for the wavelengths λⱼ of the respective optical signals Oⱼ, the digital processing unit DPU selects a ring resonator Rk for which wavelength calibration is to be performed, and identifies a DAC code value CODE_Rk corresponding to the resonance wavelength λ_{Rk} of the selected ring resonator Rk and a DAC code value CODE_Oⱼ corresponding to a wavelength λⱼ of a closest optical signal Oⱼ that is not currently assigned. When the identified DAC code value CODE_Oⱼ is greater than the DAC code value CODE_Rk corresponding to the resonance wavelength λ_{Rk} of the selected ring resonator Rk, a j-th calibration DAC code value CODE_j for calibrating the resonance wavelength λ_{Rk} of the k-th ring resonator Rk to the wavelength λⱼ of the j-th optical signal is obtained by subtracting the DAC code value CODE_Rk corresponding to the resonance wavelength λ_{Rk} of the selected ring resonator Rk from the DAC code value CODE_Oⱼ corresponding to the wavelength λⱼ of the optical signal.

However, when the identified DAC code value CODE_Oⱼ is less than the DAC code value CODE_Rk corresponding to the resonance wavelength λ_{Rk} of the selected ring resonator Rk, a j-th calibration DAC code value CODE_j for calibrating the resonance wavelength λ_{Rk} of th e k-th ring resonator Rk to the wavelength λⱼ of the j-th optical signal is obtained by subtracting the DAC code value CODE_Rk corresponding to the resonance wavelength λ_{Rk} of the selected ring resonator Rk from the FSR DAC code value CODE_{FSR} and adding the DAC code value CODE_Oⱼ corresponding to the wavelength λj of the optical signal.

That is, wavelength calibration and channel alignment operations may be performed in the same manner as in the wavelength calibration apparatus of FIG. 1.

In the illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

In addition, the wavelength calibration apparatus shown in FIGS. 1 and 4 may be implemented in a logic circuit by hardware, firmware, software, or a combination thereof or may be implemented using a general purpose or special purpose computer. The apparatus may be implemented using a hardwired device, a field programmable gate array (FPGA), or an application specific integrated circuit (ASIC). Further, the apparatus may be implemented by a system on chip (SoC) including one or more processors and a controller.

In addition, the wavelength calibration apparatus may be mounted in a computing device or server provided with a hardware element as software, hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

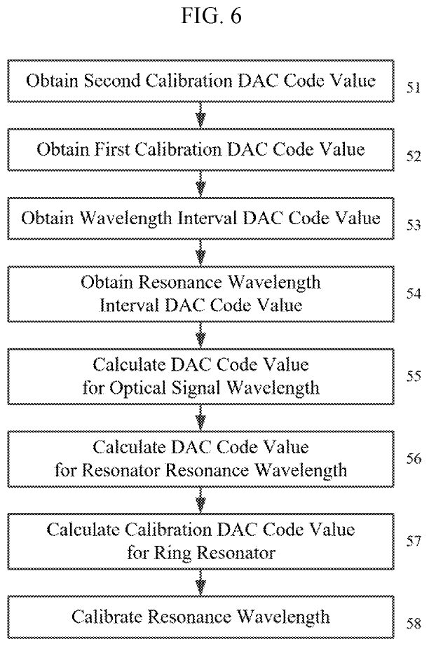

FIG. 6 illustrates a wavelength calibration method according to an embodiment.

Referring to FIG. 6, the wavelength calibration method according to an embodiment gradually increases a value of a second DAC code for adjusting a resonance wavelength of a second ring resonator R2, which is located second from an input side of a bus optical waveguide BUS among a plurality of ring resonators R1 to Rn that are sequentially coupled to the bus optical waveguide BUS and designed to have resonance wavelengths spaced apart at uniform intervals, and when a wavelength of an optical signal matching the second ring resonator R2 is detected, obtains the value of the second DAC code as a second calibration DAC code value CODE_b (51). At this time, the resonance wavelength of the second ring resonator R2 may be regarded as a second calibrated resonance wavelength.

Further, a value of a first DAC code for adjusting a resonance wavelength of a first ring resonator R1 located at a foremost input side of the bus optical waveguide BUS is increased, and when a wavelength of an optical signal matching the first ring resonator R1 is detected, the value of the first DAC code is obtained as a first calibration DAC code value CODE_a (52). Thereafter, while continuing to increase the value of the first DAC code until the resonance wavelength of the first ring resonator R1 matches the second calibrated resonance wavelength, when wavelengths of other optical signals are detected, a number m of detected wavelengths is counted, and a change in the value of the first DAC code occurring while consecutive wavelengths are detected is obtained as a wavelength interval DAC code value CODEλ (53). Here, the wavelength interval DAC code value CODE_{λ}represents a DAC code value corresponding to a wavelength interval Δλ between wavelengths of optical signals transmitted through the bus optical waveguide BUS.

In addition, when the resonance wavelength of the first ring resonator R1 matches the second calibrated resonance wavelength, a resonance wavelength interval DAC code value CODE_{Filter} corresponding to a resonance wavelength interval Δλ_{R} between resonance wavelengths λ_{R1} and λ_{R2} of the first and second ring resonators R1 and R2 is obtained (54).

When the first calibration DAC code value CODE_a, the resonance wavelength interval DAC code value CODE_{Filter}, and the FSR DAC code value CODE_{FSR} are obtained, DAC code values CODE_Oⱼ for wavelengths λⱼ of respective optical signals Oⱼ are calculated and obtained (55). In addition, DAC code values CODE_Rk for resonance wavelengths λ_{Rk} of respective ring resonators Rk are calculated and obtained (56).

Further, based on the calculated DAC code values CODE_Oⱼ for the wavelengths λj and the DAC code values CODE_Rk for the resonance wavelengths λ_{Rk}, calibration DAC code values CODE_j for correcting resonance wavelengths λ_{R3} to λ_{Rn} of remaining ring resonators R3 to Rn are calculated and obtained (57).

In this case, as described above, the calibration DAC code value CODE_j may be calculated by identifying a DAC code value CODE_Rk corresponding to a resonance wavelength λ_{Rk} of a ring resonator Rk and a DAC code value CODE_Oj corresponding to a wavelength λⱼ of a closest optical signal among wavelengths λ₂, λ₄ to λₙ, and determining whether the identified DAC code value CODE_Oj is greater than or less than the DAC code value CODE_Rk corresponding to the resonance wavelength λ_{Rk} of the selected ring resonator Rk.

When calibration DAC code values CODE_j for all of the ring resonators R1 to Rn are obtained, a plurality of optical signals are allocated to the ring resonators R1 to Rn according to the obtained calibration DAC code values CODE_j to perform channel alignment, and resonance wavelengths λ_{R1} to λ_{Rn} of the ring resonators R1 to Rn are calibrated to wavelengths λ₁ to λₙ of the allocated optical signals (58).

In FIG. 6, it is described that respective processes are sequentially executed, which is, however, illustrative, and those skilled in the art may apply various modifications and changes by changing the order illustrated in FIG. 6 or performing one or more processes in parallel or adding another process without departing from the essential gist of the exemplary embodiment of the present disclosure.

The present disclosure has been described in detail through a representative embodiment, but those of ordinary skill in the art to which the art pertains will appreciate that various modifications and other equivalent embodiments are possible from this. Therefore, the true technical protection scope of the present disclosure should be determined by the technical spirit set forth in the appended scope of claims.

What is claimed is:

1. A wavelength calibration apparatus comprising:
a bus optical waveguide configured to transmit a plurality of optical signals having different wavelengths;
a plurality of ring resonators sequentially coupled to the bus optical waveguide; and
a ring resonator controller configured to generate a digital-to-analog converter (DAC) code for controlling heat applied to the plurality of ring resonators such that resonance wavelengths of the plurality of ring resonators are calibrated to match wavelengths of the plurality of optical signals,
wherein the ring resonator controller is further configured to:
adjust the DAC code and, in response to a resonance wavelength of a second ring resonator located second from an input side of the bus optical waveguide matching a wavelength of one of the plurality of optical signals, determine a second calibration DAC code for the second ring resonator;
while increasing a resonance wavelength of a first ring resonator located closest to the input side, determine a first calibration DAC code and a wavelength interval DAC code corresponding to a wavelength interval of the plurality of optical signals, and determine a matching DAC code in response to the resonance wavelength of the first ring resonator matching the resonance wavelength of the second ring resonator; and
calculate a calibration DAC code for matching resonance wavelengths of remaining unmatched ring resonators to wavelengths of remaining optical signals based on the first calibration DAC code, the second calibration DAC code, the wavelength interval DAC code, and the matching DAC code.

2. The wavelength calibration apparatus of claim 1,
wherein the ring resonator controller is configured to:
calculate and obtain DAC codes corresponding to resonance wavelengths of remaining unmatched ring resonators and DAC codes corresponding to wavelengths of remaining optical signals using the first and second calibration DAC codes, the wavelength interval DAC code, and the matching DAC code, and
perform wavelength calibration by selecting matching DAC codes from among the DAC codes corresponding to the resonance wavelengths of the ring resonators and the DAC codes corresponding to the wavelengths of the optical signals.

3. The wavelength calibration apparatus of claim 2,
wherein the ring resonator controller is configured to:
select a DAC code corresponding to a resonance wavelength of an unmatched ring resonator,
identify a DAC code corresponding to a wavelength of an optical signal having a closest value to the selected DAC code, and
when the identified DAC code is greater than the selected DAC code, obtain a calibration DAC code for the selected ring resonator by subtracting the selected DAC code from the identified DAC code.

4. The wavelength calibration apparatus of claim 2,
wherein the ring resonator controller is configured to:
select a DAC code corresponding to a resonance wavelength of an unmatched ring resonator,
identify a DAC code corresponding to a wavelength of an optical signal having a closest value to the selected DAC code, and
when the identified DAC code is less than the selected DAC code, obtain a calibration DAC code for the selected ring resonator by subtracting the selected DAC code from an FSR DAC code corresponding to a free spectral range (FSR) of the ring resonator and adding the identified DAC code.

5. The wavelength calibration apparatus of claim 1,
wherein the ring resonator controller is configured to:
count a number of wavelengths of optical signals matched until the resonance wavelength of the first ring resonator matches the resonance wavelength of the second ring resonator, and
calculate and obtain a resonance wavelength interval DAC code corresponding to an interval between resonance wavelengths of the ring resonators based on the first and second calibration DAC codes, the wavelength interval DAC code, and the counted number.

6. The wavelength calibration apparatus of claim 5,
wherein the ring resonator controller is configured to calculate and obtain the resonance wavelength interval DAC code according to equation:
CODE_{Filter}=CODE_a+(m−1)CODE_{λ}−CODE_b
wherein CODE_{Filter} is a resonance wavelength interval DAC code, CODE_{λ}is a wavelength interval DAC code, and CODE_a and CODE_b are a first calibration DAC code and a second calibration DAC code, respectively.

7. The wavelength calibration apparatus of claim 5,
wherein the ring resonator controller is configured to obtain a DAC code corresponding to a resonance wavelength of a k-th ring resonator among the plurality of ring resonators by multiplying the resonance wavelength interval DAC code by (k−1).

8. The wavelength calibration apparatus of claim 5,
wherein the ring resonator controller is configured to
calculate and obtain a DAC code corresponding to a wavelength of a j-th optical signal among the plurality of optical signals according to equation:
CODE_Oⱼ=CODE_a+(m−1)CODE_{λ}
wherein CODE_Oⱼ is a DAC code corresponding to the wavelength (λⱼ) of the j-th optical signal, CODE_{λ}is a wavelength interval DAC code, CODE_a is a first calibration DAC code, and m is a number of optical signals having wavelengths between a first resonance wavelength (λ_{R1}) and the wavelength (λⱼ) of the j-th optical signal.

9. The wavelength calibration apparatus of claim 5,
wherein the ring resonator controller is configured to obtain an FSR DAC code corresponding to a free spectral range (FSR) of the ring resonator by multiplying the resonance wavelength interval DAC code by a number of channels corresponding to a number of the ring resonators.

10. The wavelength calibration apparatus of claim 1,
wherein the ring resonator controller is configured to:
receive detection signals corresponding to optical signal intensities detected by each of the plurality of ring resonators;
determine that a resonance wavelength of a corresponding ring resonator matches a wavelength of an optical signal when a peak of the detection signal is detected while adjusting the DAC code; and
determine that the resonance wavelength of the first ring resonator matches the resonance wavelength of the second ring resonator in response to a peak being detected in the detection signal for the first ring resonator and a negative peak being detected in the detection signal for the second ring resonator.

11. The wavelength calibration apparatus of claim 1,
wherein the plurality of ring resonators have different radii such that initial resonance wavelengths are spaced apart at uniform intervals.

12. The wavelength calibration apparatus of claim 1,
wherein each of the plurality of ring resonators is coupled with a heater heated by a heater voltage applied according to the DAC code.

13. The wavelength calibration apparatus of claim 1,
wherein the wavelength calibration apparatus is included in one of a transmitter or a receiver of a WDM system.

14. A wavelength calibration method for a plurality of ring resonators coupled to a bus optical waveguide, the method comprising:
adjusting, by a ring resonator controller, a digital-to-analog converter (DAC) code and, in response to a resonance wavelength of a second ring resonator located second from an input side of the bus optical waveguide matching a wavelength of one of a plurality of optical signals, determining a second calibration DAC code for the second ring resonator;
while increasing a resonance wavelength of a first ring resonator located closest to the input side, determining a first calibration DAC code and a wavelength interval DAC code corresponding to a wavelength interval of the plurality of optical signals;
determining a matching DAC code in response to the resonance wavelength of the first ring resonator matching the resonance wavelength of the second ring resonator; and
calculating a calibration DAC code for matching resonance wavelengths of remaining unmatched ring resonators to wavelengths of remaining optical signals based on the first calibration DAC code, the second calibration DAC code, the wavelength interval DAC code, and the matching DAC code.

15. The wavelength calibration method of claim 14,
wherein the calculating and obtaining the calibration DAC code comprises:
calculating and obtaining DAC codes corresponding to resonance wavelengths of remaining unmatched ring resonators and DAC codes corresponding to wavelengths of remaining optical signals using the first and second calibration DAC codes, the wavelength interval DAC code, and the matching DAC code; and
performing wavelength calibration by selecting matching DAC codes from among the DAC codes corresponding to the resonance wavelengths of the ring resonators and the DAC codes corresponding to the wavelengths of the optical signals.

16. The wavelength calibration method of claim 15,
wherein the ring resonator controller is configured to:
select a DAC code corresponding to a resonance wavelength of an unmatched ring resonator,
identify a DAC code corresponding to a wavelength of an optical signal having a closest value to the selected DAC code, and
when the identified DAC code is greater than the selected DAC code, obtain a calibration DAC code for the selected ring resonator by subtracting the selected DAC code from the identified DAC code.

17. The wavelength calibration method of claim 15,
wherein the ring resonator controller is configured to:
select a DAC code corresponding to a resonance wavelength of an unmatched ring resonator,
identify a DAC code corresponding to a wavelength of an optical signal having a closest value to the selected DAC code, and
when the identified DAC code is less than the selected DAC code, obtain a calibration DAC code for the selected ring resonator by subtracting the selected DAC code from an FSR DAC code corresponding to a free spectral range (FSR) of the ring resonator and adding the identified DAC code.

18. The wavelength calibration method of claim 14,
wherein the ring resonator controller is configured to:
count a number of wavelengths of optical signals matched until the resonance wavelength of the first ring resonator matches the resonance wavelength of the second ring resonator, and
calculate and obtain a resonance wavelength interval DAC code corresponding to an interval between resonance wavelengths of the ring resonators based on the first and second calibration DAC codes, the wavelength interval DAC code, and the counted number.

19. The wavelength calibration method of claim 18,
wherein the ring resonator controller is configured to calculate and obtain the resonance wavelength interval DAC code according to equation:
CODE_{Filter}=CODE_a+(m−1)CODE_{λ}−CODE_b
wherein CODE_{Filter} is a resonance wavelength interval DAC code, CODE_{λ}is a wavelength interval DAC code, and CODE_a and CODE_b are a first calibration DAC code and a second calibration DAC code, respectively.

20. The wavelength calibration method of claim 18,
wherein the ring resonator controller is configured to calculate and obtain a DAC code corresponding to a wavelength of a j-th optical signal among the plurality of optical signals according to equation:
CODE_Oⱼ=CODE_a+(m−1)CODE_{λ}
wherein CODE_Oⱼ is a DAC code corresponding to the wavelength (λⱼ) of the j-th optical signal, CODE_{λ}is a wavelength interval DAC code, CODE_a is a first calibration DAC code, and m is a number of optical signals having wavelengths between a first resonance wavelength (λ_{R1}) and the wavelength (λⱼ) of the j-th optical signal.
